(19) United States
(12) Patent Application Publication
(10) Pub. No.: US 2012/0159911 A1
(43) Pub. Date: Jun. 28, 2012

(54) CRANKCASE FILTER

(75) Inventors: Ronald P. Maloney, Peoria, IL (US); Seth E. Slaughter, Peoria, IL (US); Joshua J. Evans, Chillicothe, IL (US)

(73) Assignee: Caterpillar Inc., Peoria, IL (US)

(21) Appl. No.: 13/325,674

(22) Filed: Dec. 14, 2011

Related U.S. Application Data
(60) Provisional application No. 61/426,101, filed on Dec. 22, 2010.

(51) Int. Cl. B01D 46/00

(52) U.S. Cl. 55/385.3; 55/495; 55/423; 55/432

(57) ABSTRACT

A crankcase filter comprises a housing comprising an inlet for an oil-gas mixture, a first outlet for oil, and a second outlet for gas; a filter element within the housing with a first end and a second end and a passage between the two ends, wherein the inlet opens to the first end, and the first outlet opens to the second end; and a collector configured to collect oil to the first outlet. The oil may be captured from the passage of the filter element and from the filter element. Hereby some of the oil need not to pass through the filter. Further, the crankcase filter may include a valve between the second end and the first outlet, the valve being configured to allow only oil to exit to the first outlet. The valve may be a ball float valve.

### RELATED APPLICATIONS

This application is based upon claims the benefit of priority from U.S. Provisional Application No. 61/426,101 by Ronald P. Maloney et al., filed Dec. 22, 2010, the contents of which are expressly incorporated herein by reference.

### TECHNICAL FIELD

The present disclosure relates to filters. More particularly, the present disclosure relates to an engine crankcase filter.

### BACKGROUND

During internal combustion engine operation, blow-by gases can escape past the piston rings and enter the crankcase due to high pressure in the cylinders during compression and combustion. Pressure in the crankcase is regulated by routing the gases out of the crankcase into the engine intake system or to the atmosphere through a draft tube or similar breather vent. The crankcase gases, however, are contaminated with oil mist, wear particles and combustion byproducts, thus filtration of these gases is preferred to reduce air pollution from the gases vented to atmosphere and to reduce intake system engine contamination and deposits from gases drawn into the engine intake system.

Patent application publication US2001/0054418 discloses a crankcase emission control system. In this system an oil-gas mixture goes through a filter that separates oil from gas. In cases where the engine has high blow-by rates, however, excessive oil carry results in crankcase gases that contain heavy aerosol and liquid, which passes very slowly through a filter element. This may cause liquid “slugging” of the filter which results in efficient filtration. It would be desirable to provide a system that could capture heavy aerosol and liquid oil and return it to the crankcase, preferably in an inefficient manner.

Furthermore, a crankcase gas filtration system should be compact and combine various components into a single integrated unit. It is further desirable that a crankcase filter is simple and inexpensive to manufacture. It would be advantageous to reduce manufacture time and expenses. Filters may also be subject to local legislations and regulations, such as safety and emission regulation. A further problem is to provide a filter that is easy and simple to maintain, for example when installing the filter or changing the filter.

The present disclosure is directed to overcoming one or more of the problems as set forth above.

### SUMMARY OF THE INVENTION

In one aspect, the present disclosure is directed to a crankcase filter. The crankcase filter may include a housing comprising an inlet for an oil-gas mixture, a first outlet for oil, and a second outlet for gas; a filter element within the housing with a first end and a second end and a passage between the two ends, wherein the inlet opens to the first end, and the first outlet opens to the second end; and a collector configured to collect oil to the first outlet. The oil may be captured from the passage of the filter element and from the filter element.

In another aspect, the present disclosure is directed to an internal combustion engine or a vehicle including such a crankcase filter.

At least one of the above embodiments provides one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment(s).

### BRIEF DESCRIPTION OF THE DRAWINGS

The accompanying drawings illustrate presently preferred exemplary embodiments of the disclosure, and together with the general description given above and the detailed description of the preferred embodiments given below, serve to explain, by way of example, the principles of the disclosure.

FIG. 1 is a diagrammatic illustration of a crankcase filter according to an exemplary embodiment of the present disclosure; and

FIG. 2 is a diagrammatic illustration of a cross section A-A taken from FIG. 1.

### DETAILED DESCRIPTION

In this disclosure, including the claims, reference is made to an oil-gas mixture and that from this oil-gas mixture, oil and gas are separated from each other. This refers to the filtration of crankcase emission; the removal of contaminates from fumes and vapors emanating from a crankcase. The term oil is used broadly to include liquids, for example fuel, oil, and moisture, and solid particles of the crankcase emission that should be separated from the gas of the crankcase emission. The term gas used broadly and may include, for example air, fumes, and vapors of the crankcase emission that should be separated from the oil of the crankcase emission.

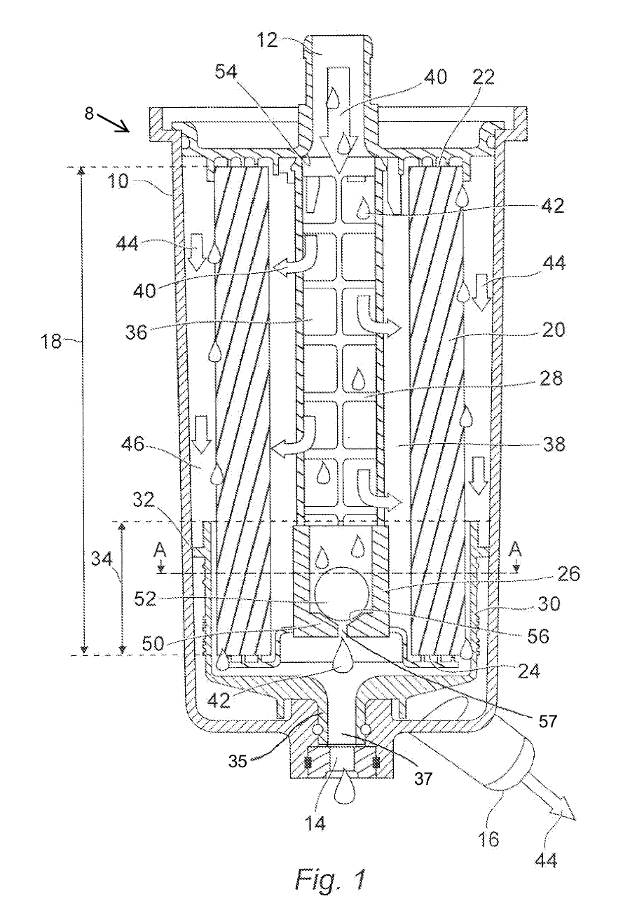

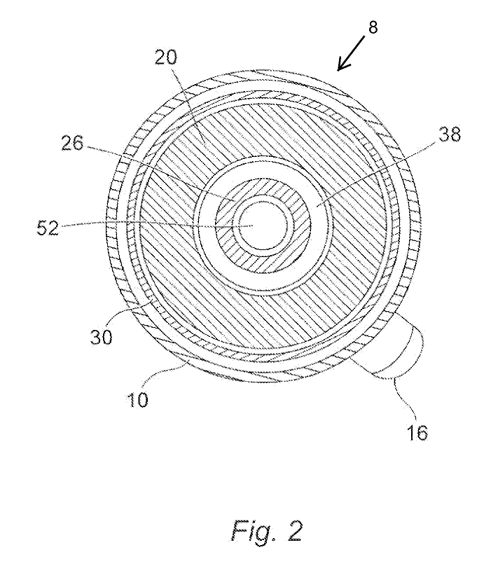

Turning to FIGS. 1 and 2, an exemplary embodiment of a crankcase filter assembly 8 is illustrated. In this embodiment, the crankcase filter assembly 8 includes a housing 10, a filter element 20, and a collector 30. The housing 10 may be configured in a variety of ways, including various shapes and sizes. In the depicted embodiment, the housing 10 has a substantially cylindrical shape and includes an inlet 12 for an oil-gas mixture 40, a first outlet 14 for oil 42, and a second 16 outlet for gas 44. The second outlet 16 may be in any suitable location of the housing 10 to allow gas 44 to exit. Preferably the second outlet 16 is below the second end 24 so that the gas 44 must flow on the outside of the filter element 20 to draw the oil 42 towards the collector 30.

The filter element 20 is disposed within the housing 10. The filter element 20 may be configured in a variety of ways, including various shapes and sizes. The filter element 20 may be any suitable filter media for filter crankcase gases, such as a coalescing filter element. In the depicted embodiment, the filter element 20 has a substantially cylindrical shape with an annular cross section. Any other suitable shape, such as a polygonal shape, may also be technically possible. The filter element 20 includes a first end 22, a second end 24, and a central passage 38 between the first end 22 and second end 24. The inlet 12 opens to the first end 22 and the first outlet 14 opens to the second end 24.

The collector 30 is configured to collect oil and direct the collected oil to the first outlet 14. The collector 30 may be configured in a variety of ways, including various shapes and sizes. In the depicted embodiment, the collector 30 has a substantially cylindrical, cup-like shape. The collector 30 may extend from the second end 24 of the filter element 20 upwards towards the first end 22 of the filter element 20 for an extension 34 of the collector. This extension 34 is within the area 46 between the housing 10 and the filter element 20. The extension 34 may be between a fourth and third of a length 18 of the filter element 20.

According to one embodiment, the collector 30 extends between the filter element 20 and the housing 10 from the second end 24 to substantially about one third of a length 18 of the filter element 20. The collector 30 may include a stem 35 having a passage 37 that is in fluid communication with first outlet 14. In the depicted embodiment, the stem 35 is received in the first outlet 14.

The collector 30 may be arranged to the housing by a rib 32. The rib 32 may have openings and/or other means for allowing the gas 44 to pass through.

The crankcase filter assembly 8 may have a valve 50 connecting the passage 38 of the filter element 20 to the first outlet 14, the valve 50 being configured to selectively allow oil 42 to exit to the first outlet 14. The valve 50 may be configured in a variety of ways. Any valve configured to allow oil to exit after a certain volume of oil has been collected, may be used. In the depicted embodiment, the valve includes a ball 52 and a collection sleeve 26.

The collection sleeve 26 is configured to collect a volume of oil. The collection sleeve may be configured in a variety of ways, including various shapes and sizes. In one embodiment the collection sleeve 26 has a substantially cylindrical, cup-like shape. The collection sleeve 26 extends from the second end 24 towards the first end 22 and is situated at or close to the second end 24 of the filter element so as to collect oil 42. In one embodiment, the collector 30 extends between the filter element 20 and the housing 10 from the second end 24 to substantially about the same extent as the collection sleeve 26.

The ball 52 is disposed within the collection sleeve 26. The collection sleeve 26 may form a valve seat 56 and a passage 57, which the ball 52 closes by engaging the valve seat 56. Thus, in the depicted embodiment, the valve 50 is a ball float valve.

The crankcase filter assembly 8 may also include a core 28 that extends from the collection sleeve 26 to the first end 22. According to one embodiment, the collection sleeve 26 and the core 28 may be one and the same integral part. The core 28 may, for example, stabilize the crankcase filter, and may guide oil 42 that is separated from the inlet gas stream, towards the collector 30 and/or valve 50. The core 28 may include openings 36. The openings 36 may for any suitable shape, size, and number. In the depicted embodiment, the openings 36 may form the core 28 in the shape of a grid. The openings may be configured to retain the ball 52 within the core 28 (i.e. smaller than the diameter of the ball). In this way, the collection sleeve 26 and the core 28 are configured to guide the ball 52 between an upper surface 54 and the valve 50.

While FIG. 2 illustrates features of the crankcase filter having complimentary cylindrical shapes, any other suitable shape may also be possible. For example, features of the crankcase filter may have complimentary polygonal shapes.

Under a normal operation condition of the crankcase filter assembly 8, the filter 20 is in a substantially vertical position within the housing 10, and therefore the second end 24 is below the first end 22. The second end 24 is received within the collector 30, which is at the bottom of the housing 10. The passage 37 of the collector is in fluid communication with the outlet 14. The collection sleeve 26 is at least partially received within the collector 30 and is disposed in the passage 38 of the filter element 20. The core 28 is received within the passage 38 of the filter element 20. In the depicted embodiment, the core 28 is generally coaxial with the collection sleeve 26, though that is not required. The ball 52 is received within the collection sleeve 26 and is movable from the valve seat 56 to open the passage 57 and may be movable along the core 28 to engage the upper surface 54.

According to one embodiment, an internal combustion engine may include an embodiment of the above disclosed crankcase filter. According to one embodiment, a vehicle may include an embodiment of the above disclosed crankcase filter.

### INDUSTRIAL APPLICABILITY

According to these and other embodiments, an efficient crankcase filter may be provided that is suitable to be used with an internal combustion engine, such as a diesel engine. At least one of the embodiments of the disclosed crankcase filter assembly 8 allows for the capture of heavy aerosol and liquid oil from the crankcase gas and return to the crankcase without passing through the filter element 20.

In operation, crankcase gases enter the inlet 12 and flow down the passage 38 of the filter element 20. The heavy aerosols and liquid in the oil-gas mixture 40 separate from the gas stream by gravity as they flow from the first end 22 to the second end 24. As the oil-gas mixture 40 is forced to turn sharply from its initial downwards direction to pass through the filter element 20, oil 42, being heavier than gas 44, continues downwards to be collected by the collector 30.

From the filter passage 38, the crankcase gas 44 flows radially outward through the filter element 20, to further remove contaminants from the gas. Oil removed by the filter element, flows downward to the bottom of the collector 30 and out of the first outlet 14.

The gas that passes through the filter element 20 is guided by the collector 30 through an area between the collector 30 and the housing 10 to the second outlet 16. The upwards extending collector 30 is closer to the filter element 20 than the housing 10 and may in that way allow gas 44 to exit while collecting oil 42 that is separated from the gas by the filter element 20.

The oil that is collected in the collection sleeve 26 is prevented from exiting by the valve 50. The ball 52 remains on the valve seat 56 until sufficient volume of the oil is collected in the collection sleeve to float the ball off the valve seat 56. Thus, the valve 50 may regulate the oil 42 return to the crankcase and prevent gas from flowing to the second outlet 16 through the passage 57 in the collection sleeve 26.

The crankcase filter assembly 8 therefore removes oil and other contaminants from the crankcase gas in two steps. First, heavy aerosols and liquid are separated from the crankcase gas by gravity in the internal passage of the filter element 20. Second, the crankcase gas is passed through the filter element which further removes oil and other contaminants from the crankcase gases. Since heavy aerosols and liquid are first separated from the gas and do not pass through the filter element, “slugging” of the filter maybe prevented. As a result, efficiency of the crankcase filter is high because the oil 42 is collected from within and outside the filter element 20 and because some of the oil 42 needs not to pass through the filter element 20.

According to one embodiment, the ball 52 is also configured to prevent oil from entering the inlet 12 should the filter be tilted greater than 90 degrees (such as during a vehicle rollover). The ball 52 may travel inside the core 28 from valve seat 56 to seal against an upper surface 54 at the first end 22. In this way, the crankcase filter assembly 8 provides a shut off valve preventing oil 42 from entering the inlet 12 in addition to regulating oil capture and return to the crankcase.

It will be apparent to those skilled in the art that various modifications and variations can be made to the crankcase filter. Other embodiments will be apparent to those skilled in the art from consideration of the specification and practice of the disclosed crankcase filter. It is intended that the specification and examples be considered as exemplary only, with a true scope being indicated by the following claims and their equivalents.

What is claimed is:

1. A crankcase filter, comprising:
a housing comprising an inlet for an oil-gas mixture, a first outlet for oil, and a second outlet for gas;
a filter element within the housing with a first end, a second end and a passage between the two ends, wherein the inlet opens to the first end, and the first outlet opens to the second end; and
a collector configured to collect oil to the first outlet, wherein the oil is captured from the passage of the filter element and from the filter element.

2. The crankcase filter according to claim 1, wherein the collector guides gas through an area between the collector and the housing to the second outlet.

3. The crankcase filter according to claim 1, wherein the collector is arranged to the housing by a rib.

4. The crankcase filter according to claim 1, wherein the collector extends between the filter element and the housing from the second end to substantially about one third of a length of the filter element.

5. The crankcase filter according to claim 1, comprising a valve connecting the passage of the filter element to the first outlet, the valve being configured to allow only oil to exit to the first outlet.

6. The crankcase filter according to claim 5, wherein the valve is a ball float valve.

7. The crankcase filter according to claim 6, further comprising a collection sleeve extending from the second end towards the first end, wherein the ball of the ball float valve is within the collection sleeve.

8. The crankcase filter according to claim 7, wherein the collector extends between the filter element and the housing from the second end to substantially about the same extent as the collection sleeve.

9. The crankcase filter according to claim 7, further comprising a core extending from the collection sleeve to the first end.

10. The crankcase filter according to claim 6, wherein the ball of the ball float valve is configured to regulate oil capture from the passage of the filter element and prevent oil to enter the inlet by sealing against an upper housing surface at the first end.

11. The crankcase filter according to claim 9, wherein the collection sleeve and the core are configured to guide the ball between an upper housing surface and the valve.

12. The crankcase filter according to claim 9, wherein the core comprises openings.

13. The crankcase filter according to claim 12, wherein the openings are configured to prevent the ball of the ball float valve from exiting the core.

14. The crankcase filter according to claim 6, further comprising a shut off valve configured to prevent oil entering the inlet, wherein the shut off valve uses the ball of the float ball valve to prevent oil from entering the inlet.

15. The crankcase filter according to claim 1, wherein the filter element is of a cylindrical shape.

16. An internal combustion engine, comprising the crankcase filter according to claim 1.

17. A vehicle, comprising the crankcase filter according to claim 1.
